(19) United States
(12) Patent Application Publication
(10) Pub. No.: US 2017/0310625 A1
(43) Pub. Date: Oct. 26, 2017

(54) Prioritized Messaging System

(71) Applicant: Dell Software, Inc., Round Rock, TX (US)

(72) Inventors: Guangning Hu, Ottawa (CA); Curtis Johnstone, Ottawa (CA)

(21) Appl. No.: 15/136,586

(22) Filed: Apr. 22, 2016

(51) Int. Cl. H04L 12/58; G06F 3/0484; G06F 17/30

(52) U.S. Cl. CPC H04L 51/22; H04L 51/36; H04L 51/26; G06F 3/04842; G06F 17/3053; H04L 51/04

(57) ABSTRACT

Techniques and systems for prioritizing messages are described. The messages may be associated with multiple message accounts of an individual and the message accounts may be administered by different message account providers. The messages may be prioritized according to priority scores determined based on priority rules. The priority rules may include components that correspond to attributes of the messages. The priority rules may also include weights for each of the respective components of the priority rules. The prioritized messages may be viewed in a user interface. In some cases, a user may modify an order of the messages in the user interface and the system may utilize the feedback from the user to change a priority rule.

### BACKGROUND

Individuals often exchange information using electronic messages. For example, individuals may send and receive information via emails, text-based message, or video-based message. Additionally, individuals may exchange information via messages on social networking sites, instant messaging applications, and discussion forums. The amount of information receiving by an individual may sometimes be difficult to manage. In some cases, client-side applications may provide mechanisms that an individual may use to manually prioritize messages. To illustrate, an individual may categorize a message or associate a flag with a message to indicate a priority of the message. In other situations, a sender of a message may indicate an importance of the message by associating an importance flag with a message. Also, an individual may specify rules that may be used to categorize messages as the messages are received or that may be used to place the messages in a specified folder within a messaging application. Rules also can be used to specify how an individual receives notifications regarding messages received.

### SUMMARY

This Summary provides a simplified form of concepts that are further described below in the Detailed Description. This Summary is not intended to identify key or essential features and should therefore not be used for determining or limiting the scope of the claimed subject matter.

Techniques and systems for prioritizing messages are described. The messages may be associated with multiple message accounts of an individual and the message accounts may be administered by different message account providers. The messages may be prioritized according to priority scores determined based on priority rules. The priority rules may include components that correspond to attributes of the messages. The priority rules may also include weights for each of the respective components of the priority rules. The prioritized messages may be viewed in a user interface. In some cases, a user may modify an order of the messages in the user interface and the system may utilize the feedback from the user to change a priority rule.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating an example system to prioritize messages from a plurality of message accounts according to some embodiments.

FIG. 2 is a diagram illustrating an example process to generate a priority rule and utilize the priority rule to prioritize messages according to some embodiments.

FIG. 3 is a diagram illustrating an example user interface showing a number of messages arranged according to respective priorities for the messages and showing user input changing the order of a message within the user interface according to some embodiments.

FIG. 4 is a block diagram illustrating an example system to prioritize messages and to access the prioritized messages according to some embodiments.

FIG. 5 is a flowchart of a first example process to prioritize messages according to some embodiments.

FIG. 6 is a flowchart of a second example process to prioritize messages according to some embodiments.

FIG. 7 illustrates an example configuration of a computing device that can be used to implement the systems and techniques described herein according to some embodiments.

### DETAILED DESCRIPTION

Described herein are systems and processes to prioritize message received by individuals. In particular, a service provider may obtain information associated with messages from a plurality of message accounts of an individual. The service provider may analyze the information associated with the messages to determine a priority score for each of the messages. Based on the priority score, the service provider may arrange the messages in a particular order. The service provider may generate a user interface that shows the messages from the plurality of message accounts arranged in the particular order.

The service provider may analyze message metadata in order to determine the priority score for each of the messages. The message metadata may include information indicating attributes of the message. For example, the message metadata may indicate a sender of the message, a number of recipients of the message, a subject line of the message, attachments of the message, and the like.

To determine a priority score for a message, the service provider may analyze the message metadata in relation to one or more priority rules. A priority rule may include a number of components and a respective weight for each component. The components of a priority rule may correspond with one or more attributes of the message being analyzed. The one or more attributes of the message being analyzed may be obtained based on the message metadata. In addition, the components of a priority rule may also correspond with historical data associated with the message accounts of the individual. Example historical data that may be related to components of a priority rule may include a number of previous messages exchanged between the sender and the individual, a percentage of messages from the sender to which the individual submits a reply, an average time between receiving a message from the sender and the individual sending a reply, and so forth. The weights of the components may indicate a level of relative importance of each component with respect to other components.

The priority rules may be generated by the service provider, by the individual, by an enterprise associated with the individual, or a combination thereof. In some cases, the priority rules may be static in that the components and weights of the priority rules do not change over time. In other cases, the priority rules may be dynamic because the components and/or weights of the priority rules may change over time. Additionally, some priority rules may include some static features and some dynamic features. For example, a priority rule may have a component that does not change over time, but does have a weight for that component that may change over time.

As messages are analyzed by the service provider, values are given to each component of one or more priority rules. To illustrate, a component of a priority rule may be related to attachments associated with the message. The value of the component may correspond to the number of attachments associated with the message, such that a message with more attachments has a higher value for the component than a message with fewer attachments. The value of the components may be correlated with the weights of the respective components and used to generate the priority scores.

In some cases, the value of a component may change. For example, a component related to an action of opening a message may have a first value when the message has not been opened and a second value after the message has been opened. Changing the value of a component included in a priority rule may change the priority score for the corresponding message. Thus, when a message has been opened and the value for the component related to the action of opening the message decreases, the priority score of the message may also decrease.

In some situations, a user may provide feedback that modifies one or more weights associated with one or more components of a priority rule. To illustrate, an individual may provide input via an input device, such as a mouse or touch screen, that changes a position of a message within the arrangement of messages in a particular order. For example, an individual may move a message from a first position to a second position that is associated with a higher priority score. After receiving the input that changes the position of the message, the service provider may conduct an analysis of the attributes of the message. Based on the analysis, the service provider may determine a component corresponding to a particular attribute of the message that is to have a higher weight relative to a previous weight. In an example, the service provider may determine that the individual received a blind courtesy copy (Bcc) of the message and the service provider may alter a weight of a component of a priority rule corresponding to the message attribute of the status of the recipient. In particular, the service provider may increase a weight of the component that corresponds to the recipient status message attribute.

In an illustrative example, the plurality of message accounts may correspond with email accounts of an individual. Additionally, a priority rule may be specified that includes components corresponding to the attributes of emails, such as the time sent, a number of attachments, whether a flag and/or category is present, and recipient status (e.g., directly addressed to the recipient, Cc, or Bcc). Weights may also be given to each of the components of the priority rule. Thus, when an individual receives an email from one of a number of email accounts of the individual, the service provider may perform an analysis of metadata of the email to determine the attributes of the email that correspond with the components of the priority rule. For example, the service provider may determine the time the email was sent, the number of attachments of the email, whether the email is associated with a flag or category, and the status of the individual with respect to the email. Based on the analysis of the metadata, the service provider may determine values for each of the components of the priority rule. To illustrate, a value may be assigned to the time sent component based on a difference between a current time and the time that the email was sent to the individual. In an example, the value of the time sent component may decrease as the time elapsed between a current time and the time the message was sent increases. In another example, the flag and/or category component may be assigned a higher value when the email has an importance flag designated by the sender. The service provider may then utilize the values for the components of the priority rule and the weights associated with the components to determine a priority score for the email. The priority score of the email may then be compared to priority scores for other emails received by the individual to determine a position of the email within an arrangement of emails. In some cases, the emails may be arranged in a user interface with the priority scores decreasing from top to bottom

By utilizing the techniques and systems described herein, individuals may access messages from multiple accounts via a single user interface. Additionally, the messages may be ordered within the user interface based on an importance to the individual that is characterized by one or more priority rules. In this way, messages are not arranged simply according to the time at which the messages were received. Rather, the messages are arranged based on an analysis of attributes of the message in relation to components of priority rules that indicate the importance of the message attributes.

Additionally, by utilizing metadata of messages to determine a priority score for the message rather than analyzing the entire content of the message, the service provider is able to save computing resources because less information is processed in order to determine the priority score. Additionally, network resource utilization is minimized because simply the metadata of messages is transferred over a network to the service provider from the message account provider to determine priority scores for the messages. The sending of the content of the message is deferred to a time when an individual decides to actually access the content. Furthermore, since the priority rules for analyzing the messages and determining priority scores may not include every attribute of the messages, only a subset of the available metadata is actually analyzed. This also decreases the amount of computing resources utilized by the service provider to determine the priority scores for the messages.

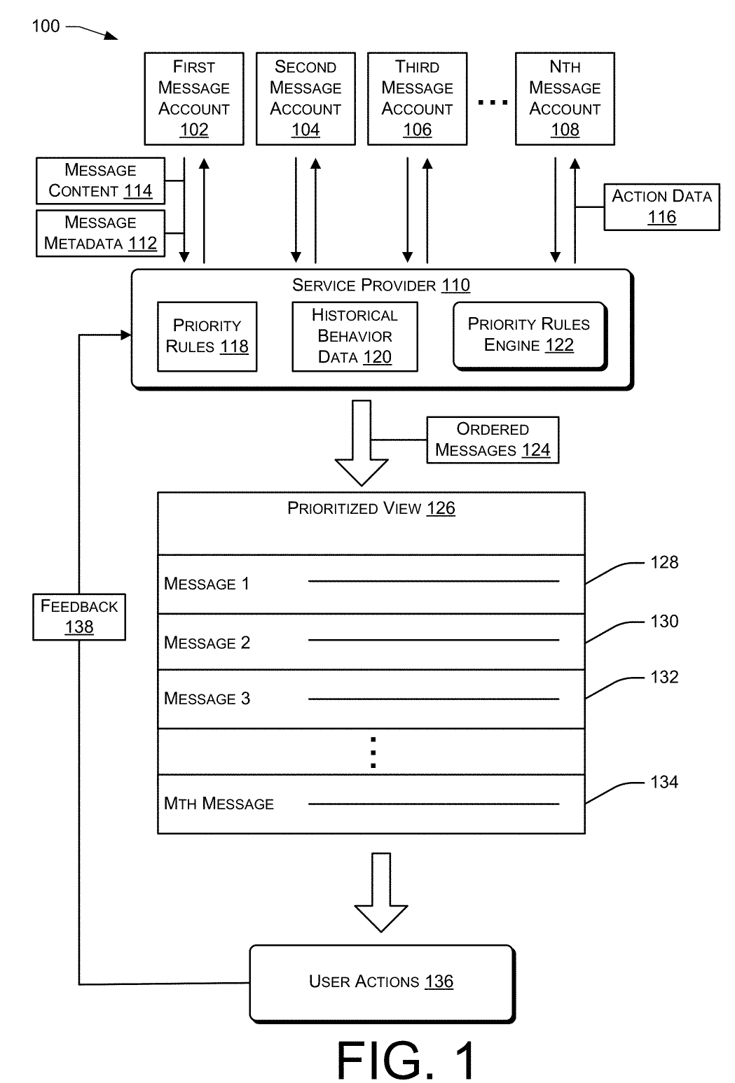

FIG. 1 is a block diagram illustrating an example system 100 to prioritize messages from a plurality of message accounts according to some embodiments. In particular, the system 100 includes a first message account 102, a second message account 104, a third message account 106, up to an Nth message account 108. The message accounts 102, 104, 106, 108 may be associated with a single individual. Additionally, the message accounts 102, 104, 106, 108 may be administered by one or more message account providers. For example, the first message account 102 may be administered by a first message account provider and the second message account 104 may be administered by a second message account provider. In another example, the first message account 102 and the second message account 104 may be administered by a first message account provider and the third message account 106 may be administered by a second message account provider.

The message accounts 102, 104, 106, 108 may be associated with one or more types of messaging accounts. For example, one or more of the message accounts 102, 104, 106, 108 may be associated with an email account of an individual. In another example, one or more of the message accounts 102, 104, 106, 108 may be associated with a messaging account of an individual, such as a Short Message Service (SMS) account a Multimedia Message Service (MMS) account, a voice message account, and the like. In an additional example, one or more of the message accounts 102, 104, 106, 108 may be associated with a messaging application, such as a messaging application executing on a mobile device or a messaging application within a social networking platform. In a further example, one or more of the message accounts 102, 104, 106, 108 may be associated with an online discussion forum. In other examples, one or more of the message accounts 102, 104, 106, 108 may be associated with a chat application, a chat forum, or an instant messaging application.

Although the illustrative embodiment of FIG. 1 indicates a particular number of message accounts, the number of message accounts associated with an individual may be greater or less than the number shown in FIG. 1. To illustrate, the system 100 of FIG. 1 may also be implemented with respect to a single message account of an individual. In other cases, the system 100 may be implemented with respect to 5 or 10 or more message accounts of an individual.

The system 100 also includes a service provider 110 that prioritizes messages and provides user interfaces including the prioritized messages. The service provider 110 may analyze data associated with messages from the message accounts 102, 104, 106, 108 to determine priority scores for the messages and utilize the priority scores to arrange the messages in an order. In particular, the service provider 110 may obtain message metadata 112 from the email accounts 102, 104, 106, 108. The message metadata 112 may indicate attributes of messages associated with each of the message accounts 102, 104, 106, 108. For example, the message metadata 112 may indicate a sender of a message, a number of recipients of a message, a time sent for a message, a number of attachments of a message, any flags and/or categories associated with the message, and so forth.

The service provider 110 may also obtain message content 114 from the message accounts 102, 104, 106, 108. The message content 114 may include text of a message, images of a message, video of a message, audio of a message, or a combination thereof. For example, the message content 114 may include the body of an email. In some embodiments, the service provider 110 may refrain from obtaining the message content 114 at the time that the message metadata 112 is retrieved. In these cases, the service provider 110 may wait until receiving input from an individual to access the content of a message before retrieving the message content 114 for the particular message. To illustrate, the service provider 110 may wait until receiving a request to open an email, before retrieving the message content 114 for the message from one of the message accounts 102, 104, 106, 108.

The service provider 110 may also exchange action data 116 with the message accounts 102, 104, 106, 108. The action data 116 may indicate that the service provider 110 has received input to perform an action with respect to a message associated with one of the message accounts 102, 104, 106, 108. The action data 116 may synchronize input received by the service provider 110 that causes a change to a message of one of the message accounts 102, 104, 106, 108 to propagate the change to the corresponding message account 102, 104, 106, 108. For example, the service provider 110 may receive input to open a message of the first message account 102. The service provider 110 may send the action data 116 to the provider of the first message account 102 indicating that the message has been opened. In this way, the provider of the first message account 102 may also change the status of the message from being unopened to opened. In another example, the service provider 110 may receive input to reply to a message associated with the third message account 106. The service provider 110 may provide the action data 116 to the provider of the third message account 106 indicating that an individual has requested to reply to the message. In these scenarios, the action data 116 may include an email address(es) of the recipient(s) of the reply message along with other data that may be used to process the reply message. In some cases, the service provider 110 may send the reply message to the corresponding recipient(s) and send additional action data to the provider of the third message account 106 indicating that the service provider 110 has sent the reply message. In other cases, the provider of the third email account 106 may send the reply message to the corresponding recipient(s) based on receiving the action data 116 from the service provider 110.

The service provider 110 may utilize one or more priority rules 118 to prioritize messages associated with the message accounts 102, 104, 106, 108. The priority rules 118 may include one or more components. Each component of a priority rule 118 may correspond to an attribute of a message. For example, a priority rule 118 may include a component that corresponds to the sender of the message. In another example, a priority rule 118 may include a component that corresponds to attachments of the message. In an additional example, a priority rule 118 may include a component that corresponds to whether or not the message has been opened. The priority rules 118 may also include weights for each of the components. The weights may indicate a level of relative importance for the respective component.

The priority rules 118 may be defined by the service provider 110. That is, the service provider 110 may specify the components of the priority rules 118 and corresponding weights for the components of the priority rules 118. In other cases, an individual associated with the message accounts 102, 104, 106, 108 may specify the components of the priority rules 118 and corresponding weights for the components of the priority rules 118. In additional situations, one or more additional entities can specify the components of the priority rules 118 and corresponding weights of the priority rules 118. For example, an enterprise that employs an individual may designate the components of the priority rules 118 and corresponding weights of the priority rules 118. By enabling individuals, additional entities, or both to provide at least a portion of the priority rules 118, the individuals and/or additional entities have the opportunity to devise customized priority rules 118.

In some situations, the service provider 110, an individual, one or more additional entities, or a combination thereof, may specify the priority rules 118. For example, the service provider 110 may specify default priority rules 118 for prioritizing messages and an individual or an additional entity may modify the default priority rules 118. To illustrate, the service provider 110 may specify a default priority rule 118 that includes a component corresponding to attachments of a message. An individual may modify the default priority rule 118 to remove the component corresponding to attachments of a message and add a component corresponding to whether or not a message has been received directly or through a forward or reply. An enterprise employing an individual associated with the message accounts 102, 104, 106, 108 may also modify default priority rules 118 set by the service provider 110.

The priority rules 118 may be static, dynamic, or a combination thereof. A static priority rule 118 may include components that do not change and weights that do not change. A dynamic priority rule 118 may include components and weights that change. In some cases, a priority rule 118 may have characteristics of both static rules and dynamic rules. For example, a priority rule 118 may have one or more components that change over time and one or more components that do not change over time. In another example, a priority rule 118 may have one or more weights that change over time and one or more weights that do not change over time. The static or dynamic nature of the priority rules 118 may be specified by the service provider 110, individuals, additional entities, or combinations thereof.

In some cases, the service provider 110 may utilize historical behavior data 120 to determine the priority rules 118. The historical behavior data 120 may indicate actions taken by individuals with respect to messages received by the individuals. For example, the historical behavior data 120 may indicate times that individuals replied to messages received by the individuals. In other examples, the historical behavior data 120 may indicate messages that individuals replied to, messages individuals forwarded, messages that individuals did not reply to, messages that individuals deleted, messages marked as spam, and so forth.

The service provider 110 may perform an analysis of the historical behavior data 120 to identify information that may be used as part of the priority rules 118. The service provider 120 may utilize analyses of the historical behavior data 120 to identify information that may be used as part of the priority rules 118 on an individual basis, on a group basis, or both. For example, the service provider 110 may analyze the historical behavior data 120 to determine a frequency that recipients of messages reply to senders of messages. In a particular example, the service provider 110 may determine that a recipient replies to messages from a first sender on average within a first period of time and that the recipient replies to messages of a second sender on average within a second period of time. The service provider 110 may also analyze the historical behavior data 120 to determine an amount of time elapsed between the receipt of messages and the opening of the messages by one or more recipients. In addition, the service provider 110 may analyze the historical behavior data 120 to determine an amount of time elapsed between the receipt of messages and replying to the messages by one or more recipients.

The service provider 110 may utilize the historical behavior data 120 to determine one or more components of the priority rules 118. The service provider 110 may also utilize the historical behavior data 120 to determine one or more weights of the priority rules 118. For example, the service provider 110 may perform an analysis of the historical behavior data 120 and determine that response times to messages received from a particular sender are shorter than response times to messages received from other senders. In this case, the service provider 110 may determine that messages received from the particular sender is one of the components of one or more priority rules 118. In another situation, the service provider 110 may assign a higher weight to a component corresponding to receiving messages from the particular sender. In addition, the service provider 110 may analyze the historical behavior data 120 to determine modifications to one or more components of the priority rules 120, modifications to weights of one or more of the priority rules 118, or both modifications to the components and weights of the priority rules 120.

The service provider 110 may include a priority rules engine 122 to determine priority scores for messages. In particular, the priority rules engine 122 may utilize the priority rules 118 to determine the priority scores from the message accounts 102, 104, 106, 108. In some embodiments, the priority rules engine 122 may utilize portions of the message metadata 112 that correspond with components of the priority rules 118 being applied to one or more messages from the message accounts 102, 104, 106, 108. For example, the priority rules engine 122 may determine that a priority rule 118 to be applied to a particular message includes a component corresponding to flags and/or categories of messages and a component corresponding to messages being directly addressed to a recipient, as opposed to receiving a courtesy copy of a message. The priority rules engine 122 may perform a first analysis of the message metadata 112 for the particular message to determine whether the particular message is associated with any categories or flags and determine a value for the flags and/or categories component based on the analysis. The priority rules engine 122 may also perform a second analysis of the message metadata 122 for the particular message to determine whether the recipient was a direct recipient of the particular message to determine a value for the directly addressed as a recipient component. Based on the values for the components of the priority rule 118 for the particular message and the weights of the priority rule 118 corresponding to the components, the priority rules engine 118 may determine a priority score for the particular message.

The priority rules engine 118 may continue to utilize the message metadata 112 and apply the priority rules 118 to determine priority scores for a number of messages of an individual associated with the message accounts 102, 104, 106, 108. The priority rules engine 118 may determine an order for the number of messages according to the priority scores for the messages. In some embodiments, the priority rules engine 118 may order the messages from highest priority score to lowest priority score to produce ordered messages 124.

The service provider 110 may utilize the ordered messages 124 generated by the priority rules engine 122 to generate a prioritized view 126. The prioritized view 126 may include a user interface that includes a number of messages arranged according to the order determined by the priority rules engine 122. In the illustrative example of FIG. 1, the prioritized view 126 includes a first message 128, a second message 130, a third message 132, up to an Mth Message 134. In some embodiments, the first message 128 may have a higher priority score than the second message 130, the third message 132, up to the Mth message 134. Additionally, the second message 130 may have a higher priority score than the third message 132 up to the Mth message 134 and the third message 132 may have a higher priority score than messages up to the Mth message 134. The user interface that includes the prioritized view 126 may be rendered and displayed via an electronic device of an individual, such as a mobile device, a wearable computing device, a tablet computing device, a laptop computing device, a desktop computing device, and the like, based on user interface information provided by the service provider 110 to the electronic device.

User actions 136 may be performed by an individual with respect to the messages included in the prioritized view 126. For example, the messages 128, 130, 132, 134 may be opened, forwarded, replied to, deleted, associated with a particular category, combinations thereof, and so forth. In some cases, the user actions 136 may correspond with input from an individual to modify an order of the messages 128, 130, 132, 134. To illustrate, an individual may provide input to move the third message 132 to be placed between the first message 128 and the second message 132. In this way, the individual may indicate an importance of the third message 132 with respect to the second message 130.

In some embodiments, the user actions 136 may be used as feedback 138 by the service provider 110. For example, when an individual moves a message in the prioritized view 126 from one position to another, the service provider 110 may modify one or more weights of a priority rule 118. To illustrate, based on receiving input that an individual moves the third message 132 to a position between the first message 128 and the second message 130, the service provider 110 may perform an analysis of attributes of the third message 132 with regard to other messages of the message accounts 102, 104, 106, 108. Based on the analysis of the attributes of the third message 132, the service provider 110 may determine that a weight of a component of one or more of the priority rules 118 may be modified. In an illustrative example, the service provider 110 may determine that a weight of a component of a priority rule 118 corresponding to a number of attachments is to be assigned a higher weight because the third message 132 may have one or more attachments, while the second message 130 may not have any attachments.

The feedback 138 may also be utilized by the service provider 110 to modify values associated with components of the priority rules 118. For example, the service provider 110 may receive input indicating that an individual has opened the first message. The service provider 110 may then modify a value of a priority rule 118 corresponding to messages being opened. Based on the modification to the value of the component corresponding to messages being opened, the priority rules engine 122 may perform an additional analysis with regard to the attributes of the first message 128 according to the priority rules 118. The additional analysis by the priority rules engine 122 may determine that an additional priority score for the first message 128 is lower than the initial priority score for the first message 128. In these situations, the priority rules engine 122 may determine that the order of the messages included in the prioritized view is to be modified. To illustrate, the priority rules engine 122 may determine that after the first message 128 has been opened, the priority score of the first message 128 is less than the priority score of the third message 132. In this scenario, the prioritized view 126 may be updated to indicate that the first message 128 is positioned below the third message 132 in the prioritized view 126.

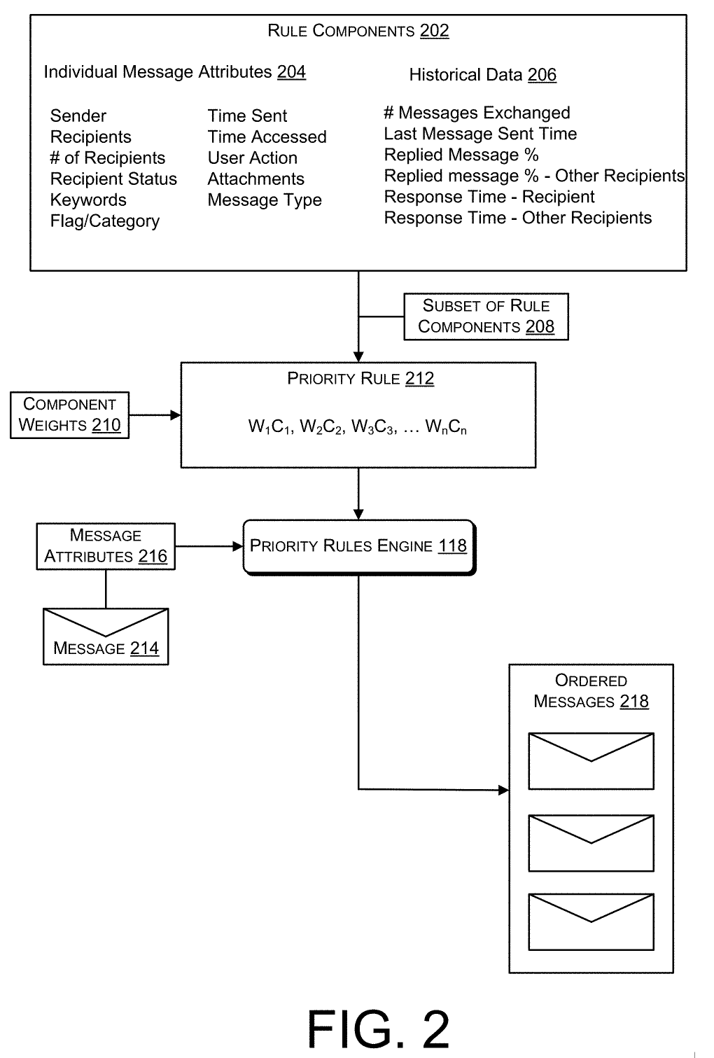

FIG. 2 is a diagram illustrating an example process to generate a priority rule and utilize the priority rule to prioritize messages according to some embodiments. In particular, a number of rule components 202 may be used to generate one or more priority rules to prioritize messages. The rule components 202 may include individual message attributes 204 and historical data 206. As explained with respect to FIG. 1, the rule components 202 may be assigned values when determining priority scores for a particular message.

The individual message attributes 204 may include a number of different attributes. For example, the individual message attributes 204 may include the sender of the message. In some cases, the sender of the message may indicate a priority of a message. To illustrate, senders of messages may be associated with an organizational chart. Individuals within certain positions of the organizational chart may be associated with a higher value for the sender rule component than individuals in different positions of the organizational chart. In other scenarios, an individual associated with a message account or an entity, such as an enterprise, associated with a message account may specify that certain senders are to be associated with higher values for a sender rule component than other senders.

The individual message attributes 204 may also include the recipients of a message. In an example, a higher value may be associated with a recipient rule component when one or more specified individuals are recipients of a message. In some cases, the recipient rule component may also be associated with an organizational chart and the value of a recipient rule component may depend on the positions of the recipients within the organizational chart. Additionally, the value of a recipient rule component may depend on preferences set by an individual or an entity, such as an enterprise, that certain recipients are to be associated with higher values for a recipient rule component.

In addition, the individual message attributes 204 may include the number of recipients of a message and the recipient status. For example, messages having a higher number of recipients may be associated with lower values for a number of recipients rule component. In other examples, one or more thresholds may be established for the values provided to a number of recipients rule component. To illustrate, a message having from 1 to 5 recipients may be associated with a first set of values, while a message having from 6 to 12 recipients may be associated with a second set of values. Further, recipient status may refer to whether an individual receiving the message was directly addressed, received a courtesy copy, or received a blind courtesy copy.

In some embodiments, the individual message attributes 204 may include keywords and flag/category. The keywords may include one or more words that are included in a subject line of a message or words included in a title of a message. Additionally, the keywords may include one or more words included in a body of a message. Further, the keywords may be associated with an attachment of a message or a file otherwise associated with a message. The flag/category rule component may refer to any flags or categories that may be associated with messages. For example, some messages may be associated with an importance flag designated by a sender or a recipient of the message. A category may be designated by an entity, by an individual, or both. To illustrate, an entity may categorize unwanted messages as spam messages. In another example, an individual may categorize messages as “financial” or “personal.” The flags or categories may be associated with certain values. In particular, some categories or flags may be associated with higher values for a flag/category rule component than other categories or flags.

The individual message attributes 204 may also include time sent and time opened. The time sent may refer to the time that the message was sent by the sender. The time sent may be specified by a server along the electronic distribution path of the message, by a computing device used to generate the message, or both. In some cases, values for a time sent rule component may decrease when the difference between a current time and the time sent increases. That is, messages sent more recently may have higher values for a time sent rule component. The time opened may include a time that a computing device received input to open a message. The values for a time opened rule component may decrease the longer that a message goes without being opened.

The individual message attributes 204 may also include user action and attachments. User actions may include actions that a user may perform with respect to a message such as replying to a message or forwarding a message. User actions may also include deleting a message or moving a message to a different folder. Messages associated with some user actions may have an increased value for a user actions rule component. For example, a message that has been forwarded may have a higher value than a message that has not been forwarded. In another example, a message that has been replied to or deleted may be assigned a lower value than a message that has not been replied to or a message that has not been deleted. The attachments rule component may refer to a number of attachments for a particular message. In some cases, messages with more attachments may have a higher value for an attachments rule component than messages with fewer attachments or messages with no attachments.

Additionally, message type may be an individual rule attribute 204. Message type may refer to whether the message is a text message, a video message, an audio message, or a combination thereof. In various embodiments, some types of messages may be designated as having higher values than other types of messages. In some situations, a video message may have a higher value than a text message or an audio message.

The historical data 206 may include number of messages exchanged between one or more recipients and one or more senders. In some cases, the greater the number of messages exchanged between a recipient and a sender, the higher the value may be for a number of messages exchanged rule component. Additionally, the historical data 206 may include a last message sent time indicating an amount of time that has elapsed between the most recent message sent to a recipient and a current time. In some scenarios, the longer the amount of time between the last message sent by a particular sender, the lower the value may be for the last message sent time rule component.

The historical data 206 may also include replied message percentage from a recipient of a particular message and the replied message percentage from other recipients receiving the message. To illustrate, the replied message percentage may include a percentage of the time that a particular recipient of a message has responded to the sender of the message. The replied message percentage for other recipients may include a percentage of time that other recipients of the same message or different messages have replied to the sender of the message. In an illustrative example, as the percentage increases of replies by a particular recipient or by a number of other recipients with respect to messages received from a sender, the value for a rule component 202 based on the replied message % or the replied message % for other recipients may also increase.

Also, the historical data 206 may include a response time to the sender by the recipient of a message. Additionally, a response time to the sender by other recipients of the message or to other recipients of other message sent by the sender. The response time may include an average amount of time elapsed from the receipt of messages by a sender to the time a response was sent to the messages. In some embodiments, as the response time increases, the value for the response time for a recipient rule component or a response time for other recipients component may decrease. That is, a service provider may determine that the longer the response time with respect to messages sent by a particular sender, the less of a priority messages received from the sender are for one or more recipients.

A subset of the rule components 208 and component weights 210 may be used to form a priority rule 212. For example, the subset of the rule components 208 may be selected by a service provider to determine the priority rule 212. In some cases, the subset of the rule components 208 may be selected based on input from an entity or one or more individuals. Additionally, the component weights 210 may also be determined by a service provider. For example, the rule components may be determined by performing an analysis of data associated with a number of messages to determine rule components that may be more or less important to individuals receiving messages. In the illustrative example of FIG. 2, the priority rule 212 may include a first rule component C₁ associated with a first component weight W₁, a second rule component C₂ associated with a second component weight W₂, a third rule component C₃ associated with a third component weight W₃ up to a n^{th} rule component Cₙ associated with an n^{th} weight component Wₙ.

The priority rule 212 may be utilized by the priority rules engine 118 to determine a priority score for a message 214 based on message attributes 216, as explained previously with respect to FIG. 1. The message 214 may be a message that was newly received by a message account of an individual, in some cases. In other situations, the message 214 may be a message that had previously been assigned a priority score. In these situations, the priority score for the message 214 may be re-calculated due to a change in the value of one of the components C₁-Cₙ or a change in one of the weights W₁-Wₙ. In certain embodiments, the message attributes 216 may be determined based on metadata associated with the message 214. In other embodiments, the message attributes 216 may be determined based on metadata associated with the message 214 and information associated with content of the message 214, such as text, audio, video, or a combination thereof, included in the body of the message 214. The priority rules engine 118 may determine a priority score for the message 214 and determine a position of the message 214 within the ordered messages 218. The ordered messages 218 and the message 214 may be associated with multiple message accounts and be accessible via a user interface including a prioritized view, such as the prioritized view 126 of FIG. 1.

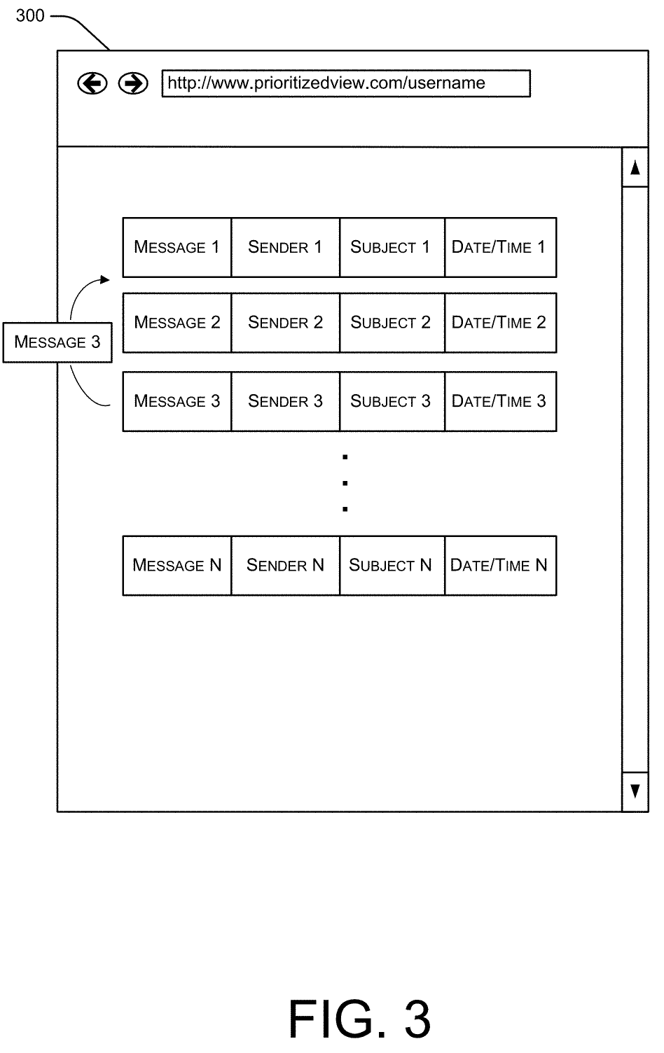

FIG. 3 is a diagram illustrating an example user interface 300 showing a number of messages arranged according to respective priorities for the messages and showing user input changing the order of a message within the user interface according to some embodiments. The user interface 300 may include the prioritized view 126 of FIG. 1, in some scenarios. In some cases, the user interface 300 may be a Web-based user interface that is accessible via a browsing application. In other situations, the user interface 300 may be accessible via an application executing on an electronic device, such as a mobile device app. In additional embodiments, the user interface 300 may be accessible via a plug-in of a messaging application. In particular embodiments, the user interface 300 may be accessible via an account of an individual with a service provider, such as the service provider 110 of FIG. 1. Thus, an individual may log in to an account with the service provider to access the prioritized view included in the user interface 300. The credentials (e.g., log-in identifier, password, biometric information) utilized by the individual to access the account with the service provider may be different from credentials utilized by the individual to log in to accounts with message account providers associated with the messages displayed in the user interface 300.

The user interface 300 may include information about a number of messages, such as a first message, Message 1; a second message, Message 2; a third message, Message 3; up to an N^{th} message, Message N. The user interface 300 may indicate a sender of the messages, a subject of the messages, and a date/time of receipt or date/time of sending of the messages. In an illustrative example, the messages included in the user interface 300 may include emails. The messages may be selectable to perform actions with respect to the messages. In some examples, the messages may be selectable to change the opposition of the messages within the user interface 300. For example, the user interface 300 also shows input moving the Message 3 to a different position within the arrangement of messages in the user interface 300. In particular, the user interface 300 shows input moving Message 3 from a position below Message 2 to a position between Message 1 and Message 2.

In some cases, the change in position of Message 2 and Message 3 may cause a service provider to re-calculate priority scores associated with at least Message 2 and Message 3. Additionally, the change in position of Message 2 and Message 3 may cause a service provide to perform an analysis of the attributes of Message 2 and Message 3 to determine attributes of Message 3 that brought about the input moving Message 3 to a different position within the user interface 300. The service provider may modify weights associated with rule components that correspond with one or more attributes that the service provider predicted causing the change in position of Message 3. For example, the service provider may determine that the input changing the position of Message 3 occurred due to Message 3 including one or more attachments. Continuing with this example, the service provider may increase a weight associated with a rule component corresponding to the number of attachments to a message.

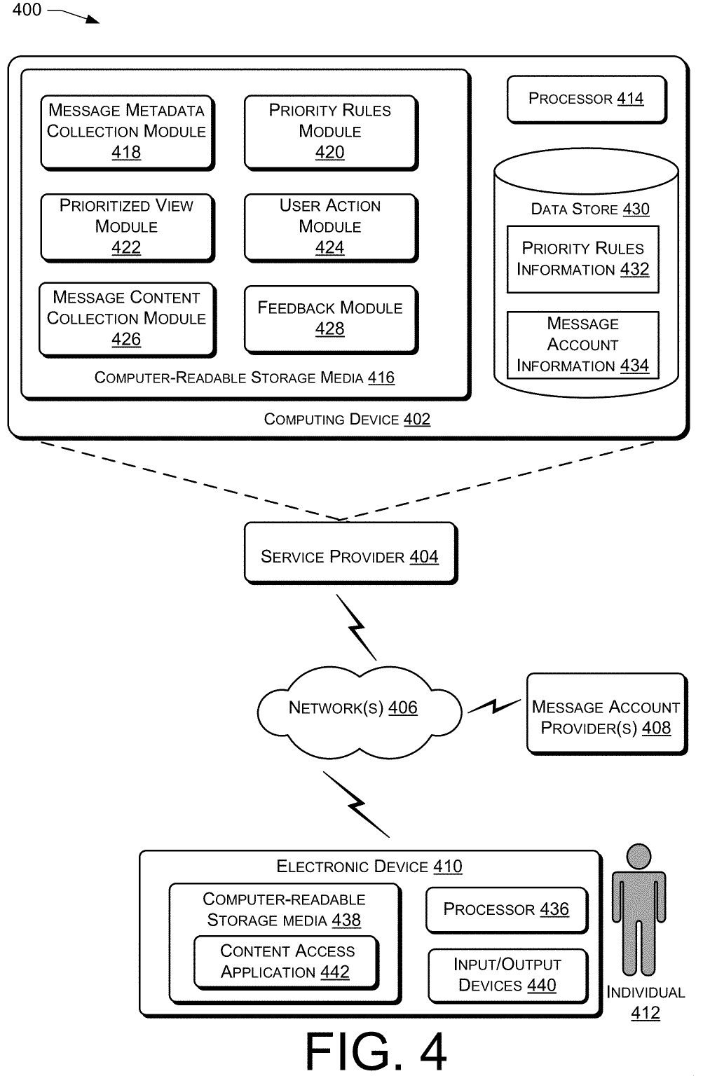

FIG. 4 is a block diagram illustrating an example system 400 to prioritize messages and to access the prioritized messages according to some embodiments. The system 400 includes a computing device 402 that is associated with a service provider 404. The service provider 404 may utilize the computing device 402 to generate prioritized views of messages for multiple message accounts of individuals. The computing device 402 may include one or network interfaces (not shown) to communicate with other computing devices via one or more networks 406. The one or more networks 406 may include one or more of the Internet, a cable network, a satellite network, a wide area wireless communication network, a wired local area network, a wireless local area network, or a public switched telephone network (PSTN).

In particular embodiments, the service provider 404 may communicate over the one or more networks 406 with one or more message account providers 408. The one or more message account providers 408 may administer message accounts for individuals, for entities, or both. In some embodiments, the message account providers 408 may store data associated with messages and data associated with the exchange of messages between individuals that have accounts with the message account providers 408. In some cases, the message account providers 408 may restrict access to messages of accounts administered by the message account providers 408. For example, the message account providers 408 may provide access to message accounts based on identifiers of individuals, passwords, encryption keys, and so forth that correspond with the message accounts administered by the message account providers 408.

The computing device 402 may also communicate via the one or more networks 406 with an electronic device 410 associated with an individual 412. The electronic device 410 may include a laptop computing device, a tablet computing device, a mobile communications device (e.g., a mobile phone), a wearable computing device (e.g., watch, glasses, fitness tracking device, and jewelry), a desktop computing device, a gaming device, combinations thereof, and the like. The individual 412 may utilize the electronic device 410 to access message accounts administered by the message account providers 408. Additionally, the individual 412 may utilize the electronic device 410 to access a prioritized view of messages that is produced by the computing device 402.

The computing device 402 may include one or more processors, such as processor 414. The one or more processors 414 may include at least one hardware processor, such as a microprocessor. In some cases, the one or more processors 414 may include a central processing unit (CPU), a graphics processing unit (GPU), or both a CPU and GPU, or other processing units. Additionally, the one or more processors 414 may include a local memory that may store program modules, program data, and/or one or more operating systems.

In addition, the computing device 402 may include one or more computer-readable storage media, such as computer-readable storage media 416. The computer-readable storage media 416 may include volatile and nonvolatile memory and/or removable and non-removable media implemented in any type of technology for storage of information, such as computer-readable instructions, data structures, program modules, or other data. Such computer-readable storage media 416 may include, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, removable storage media, or any other medium that can be used to store the desired information and that can be accessed by a computing device. Depending on the configuration of the computing device 402, the computer-readable storage media 416 may be a type of tangible computer-readable storage media and may be a non-transitory storage media.

The computer-readable storage media 416 may be used to store any number of functional components that are executable by the one or more processors 414. In many implementations, these functional components comprise instructions or programs that are executable by the one or more processors 414 and that, when executed, implement operational logic for performing the operations attributed to the computing device 402. Functional components of the computing device 402 that may be executed on the one or more processors 414 for implementing the various functions and features related to generating prioritized views of messages, as described herein, include a message metadata collection module 418, a priority rules module 420 a prioritized view module 422, a user action module 424, a message content collection module 426, and a feedback module 428.

The computing device 402 may also include, or is coupled to, a data store 430 that may include, but is not limited to, RAM, ROM, EEPROM, flash memory, one or more hard disks, solid state drives, optical memory (e.g. CD, DVD), or other non-transient memory technologies. The data store 430 may maintain information that is utilized by the computing device 402 to perform operations related to generating prioritized views. For example, the data store 430 may store priority rules information 432. In addition, the data store 430 may store message account information 434 related to accounts of individuals with the message account providers 408.

In particular, the priority rules information 432 may include information regarding priority rules that may be used to determine priority scores for messages associated with accounts administered by the message account providers 408. At least a portion of the priority rules information 432 may be provided by the service provider 404, in some cases. For example, the service provider 404 may provide default priority rules with particular components and weights. Additionally, at least a portion of the priority rules information 432 may be provided by individuals associated with message accounts administered by the message account providers 408. Further, at least a portion of the priority rules information 432 may be provided by an organization that is related to individuals associated with message accounts administered by the message account providers 408.

In some embodiments, the priority rules may include one or more components that correspond with respective attributes of messages. For example, a priority rule may include a component corresponding to a number of attachments of a message. In another example, a priority rule may include a component corresponding to flags/categories associated with messages. Additionally, the priority rules may include weights for each of the components of the priority rules. The weights may indicate a relative importance associated with a particular component. Furthermore, the priority rules information 432 may include information related to assigning values to components of the priority rules. The values may be assigned to components based at least partly on the attributes of particular messages. To illustrate, the priority rules information 432 may include one or more schemes that specify the assignment of values to components of priority rules. Tables 1-4 below indicate illustrative examples of one or more schemes that may be used to assign values to components of priority rules.

Table 1 illustrates a scheme for assigning values to rule components corresponding to attributes of a message, such as importance flag, # of recipients, recipient status (“Received as ‘To’”), message status (“Read flag”), action taken, and received as directly addressed. In an illustrative example, values may be assigned to components based on an analysis of message attributes in relation to the scheme of Table 1. To illustrate, a priority rule component corresponding to an importance flag may be assigned a value of 1 based on a message being associated with a High importance flag, a value of 0 based on a message being associated with no importance flag or a Normal importance flag, and a −1 based on a message being associated with a Low importance flag.

TABLE 1
Simple Message attributes

| | Value | | |
|---|---|---|---|
| Component | Range | Evaluation Method | Consideration |
| Importance | 1, 0, −1 | High importance → 1 | “High importance” set by |
| flag | | Normal → 0 | message sender will raise |
| | | Low importance → −1 | the priority. “Low |
| | | | importance” will lower the |
| | | | priority. |
| # of recipients | 0 to 1 | $\frac{1}{\# of recipients}$ | More recipients will lower the priority |
| Received as | 0 or 1 | Received as To → 1 | Received as “To” has a |
| To | | Received as Cc → 0 | higher priority than |
| | | | received as “Cc” |
| Read flag | 0 or 1 | Has been read → 0 | Priority get lower when |
| | | Not read yet → 1 | message has been opened |
| Action | 0 or 1 | Has replied or | Priority is lower when |
| taken | | forwarded → 0 | message has been replied |
| | | No action taken → 1 | to or forwarded |
| Received as | 0 or 1 | Directly addressed → 1 | Received as directly |
| directly | | Received through | addressed will have a |
| addressed | | distribution group → 0 | higher priority |

In some embodiments, an organization may be arranged according to an organizational chart that has one or more hierarchies having different levels. The levels of a hierarchy may be associated with certain positions within the organization. For example, a factory worker may be associated with a position on one level of a hierarchy, while a manager is associated with a position on another level of a hierarchy, and the president of the organization is associated with an additional level of the hierarchy. Thus, senders and recipients of messages may occupy various positions within an organizational hierarchy. Table 2 illustrates a scheme for assigning values to rule components related to relationships within an organization, such as a sender's relative relationship to a recipient, other recipients' relative relationship to a particular recipient, a position of a sender within an organizational hierarchy, and a position of other recipients within an organizational hierarchy. In an illustrative example, values may be assigned to components based on an analysis of a sender's relative relationship with respect to one or more recipients. To illustrate, a sender's relative relationship with respect to a recipient may indicate a difference between a level of the sender and a level of a recipient within an organizational hierarchy. In another illustrative example, a sender's absolute position within a hierarchy may be used to assign values to components of priority rules. For example, a sender at a first level within an organizational hierarchy, such as an executive level, may have a higher relative importance than a sender at a second level within an organizational hierarchy, such as a management level.

TABLE 2
Organization Chart related components

| | Value | | |
|---|---|---|---|
| Component | range | Evaluation Method | Consideration |
| Sender's relative relationship | 0 to 1 | $\frac{1}{graph distance}$ | Sender with closer relationship will have a higher priority Graph distance is 1 for direct |
| | | | manager and direct report. For |
| | | | the other people in the chart, |
| | | | the graph distance is the |
| | | | distance sum to the shared |
| | | | ancestor in the tree. |
| Other recipients relative | 0 to 1 | $\frac{1}{graph distance}$ | To cover the case that the message is also sent to a manager or direct report. |
| relationship | | | Same graph distance |
| | | | calculation as above. |
| Sender's absolute hierarchy | 0 to 1 | $1 - \frac{root distance}{height}$ | Sender at higher level will make this message have a higher priority. |
| | | | Root distance is the graph |
| | | | distance from sender to the |
| | | | organization chart root. |
| | | | Height is the total number of |
| | | | levels in the organizational chart. |
| Other recipient's absolute | 0 to 1 | $1 - \frac{root distance}{height}$ | To cover the case that the message is also sent to high level managers. |
| hierarchy | | | Same evaluation method as above |

Table 3 illustrates a scheme for assigning values to components of priority rules related to historical statistics for messages exchanged between a sender and one or more recipients. In an illustrative example, values may be assigned to priority rule components based on a percentage of messages from a sender that are replied to by one or more recipients and an amount of time that elapses between the sending of a message by a particular sender and a reply to the message from one or more recipients. To illustrate, a higher value may be assigned to a replied percentage from sender priority rule component based on a message from a sender that historically has a higher percentage of replies from the recipient than for another sender with a lower percentage of replies by the recipient. In other situations, a higher value for a response time to the sender priority rules component may be assigned to a message from a sender with an average response time by the recipient that is less than for other messages received by the recipient from other senders.

TABLE 3
Historical Statistics

| | Value | | |
|---|---|---|---|
| Component | range | Evaluation Method | Consideration |
| Replied percentage from the | 0 to 1 | $\frac{\# of replied messages}{\# of total messages}$ | Higher percentage of reply historically to the sender will make the message |
| sender | | | have a higher priority |
| Replied percentage from the | 0 to 1 | $\frac{\# of replied messages}{\# of total messages}$ | Same idea but for other recipients |
| recipients | | | |
| response time to the sender | 0 to 1 | $\frac{1}{response time order}$ | Historically replying to this sender's messages faster will make the |
| | | | message have a higher |
| | | | priority. |
| | | | Sort the historical |
| | | | response time from |
| | | | different senders and |
| | | | put them in order. |
| | | | The shortest response |
| | | | time sender will have a |
| | | | value of 1. |
| response time for other | 0 or 1 | $\frac{1}{response time order}$ | Same idea for other recipients |
| recipients | | | |

Table 4 illustrates a scheme for assigning values to priority rule components based on keywords associated with messages. For example, a priority rule component may be related to a subject line or a body of a message including a particular word or combination of words. The value of the priority rules component associated with the keyword(s) may depend on the correspondence between the keyword(s) and the words included in the message. In some cases, natural language processing techniques may be utilized to recognize synonyms of the keyword(s) included in the message.

TABLE 4
Keyword components

| | Value | Evaluation | |
|---|---|---|---|
| Component | range | Method | Consideration |
| “important” | 0 to 1 | Has keyword or | Message with keywords will |
| keyword in | | synonyms → 1 | have a higher priority. |
| subject | | No keyword or | Check all the synonyms created |
| | | synonyms → 0 | from natural language |
| | | | processing technology. |
| “important” | 0 to 1 | Has keyword or | Same idea for body |
| keyword in | | synonyms → 1 | |
| body | | No keyword or | |
| | | synonyms → 0 | |
| “emergency” | 0 to 1 | Has keyword or | Message with keywords will |
| keyword in | | synonyms → 1 | have a higher priority. |
| subject | | No keyword or | Check all the synonyms created |
| | | synonyms → 0 | from natural language |
| | | | processing technology. |
| “emergency” | 0 to 1 | Has keyword or | Same idea for body |
| keyword in | | synonyms → 1 | |
| body | | No keyword or | |
| | | synonyms → 0 | |

The message account information 434 may include information for the computing device 402 to access data corresponding to messages of accounts administered by the message account providers 408. For example, the message account information 434 may include credentials of individuals to obtain data from the message account providers 408. To illustrate, the message account information 434 may include identifiers of individuals, passwords of individuals, other credentials of individuals, and combinations thereof, to obtain message data from the message account providers 408. In some cases, the message account information 434 may include encryption keys to decrypt data obtained from the message account providers 408 and to encrypt data sent to the message account providers 408. Additionally, the message account information 434 may include application programming interface (API) information. In particular embodiments, the message account information 434 may include information related to API calls that may be used to access message data maintained by the message account providers 408.

The message metadata collection module 418 may include computer-readable instructions that are executable by the processor 414 to obtain message metadata from the message account providers 408. The message metadata collection module 418 may obtain message metadata for messages associated with a plurality of message accounts of an individual, such as the individual 412. For example, the message metadata collection module 418 may obtain first message metadata for a first number of messages from a first message account provider 408 and obtain second message metadata for a second number of messages from a second message account provider 408. In some cases, the messages associated with the first message account provider 408 and the second message account provider 408 may be a same type of message, such as emails or SMS messages. In other situations, the messages associated with the first message account provider 408 and the second message account provider 408 may be a different type of message. To illustrate, the messages associated with the first message account 408 may be emails and the messages associated with the second message account 408 may be SMS messages. In some cases, the message metadata collection module 418 may utilize a memory cache to store the message metadata while the message metadata is being used by the priority rules module 420 to determine priority scores and then discarded or moved to the data store 430 after the priority scores have been determined.

In particular embodiments, the message metadata collection module 418 may utilize portions of the message account information 434 to access message metadata from the message account providers 408. For example, the message metadata collection module 418 may utilize one or more API calls to obtain message metadata from the message account providers 408. Additionally, the message metadata collection module 418 may utilize credentials of individuals, such as login identifiers and passwords, to obtain message metadata from the message account providers 408. In some cases, the message metadata collection module 418 may obtain and utilize administrator permissions to obtain the message metadata from the message account providers 418. In various embodiments, the administrator permissions may be read-only permissions with regard to the message metadata. Further, the message metadata collection module 418 may utilize a post office protocol (POP) to obtain message metadata from the message account providers 408. In an illustrative example, the message metadata collection module 418 may utilize a POP3 protocol.

In some cases, the message metadata collection module 418 may obtain headers of messages from the message account providers 408. Also, the message metadata collection module 418 may extract specified attributes from the message metadata. For example, the message metadata collection module 418 may obtain certain information from the message account providers 408 that is to be utilized by the priority rules module 420 to determine priority scores for one or more messages. To illustrate, the priority rules engine 420 may utilize a priority rule including a component corresponding to a number of attachments of a message. In these situations, the message metadata collection module 418 may obtain message metadata indicating the number of attachments of a message from a message account provider 408 administering the message. By simply obtaining the portions of the message metadata that are utilized by the priority rules engine 420 based on the components of a priority rule, the message metadata collection module 418 utilizes fewer resources of the one or more networks 406 because only a portion of the message metadata for a particular message is communicated over the one or more networks 406 and not the entirety of the message metadata for the particular message.

The priority rules module 420 may include computer-readable instructions that are executable by the processor 414 to determine priority scores for messages based on the priority rules information 432 and based on an analysis of data associated with the messages. In various embodiments, the priority rules module 420 may include at least a portion of the priority rules engine 118 of FIG. 1 and FIG. 2. In some cases, the analysis performed by the priority rules module 420 may be based on message metadata obtained from the message account providers 408 by the message metadata collection module 418. By simply analyzing the message metadata to determine priority scores for messages rather than analyzing a larger amount of the message data, the use of computing resources, such as processing resources and memory resources, is minimized.

In particular embodiments, the priority rules module 420 may determine one or more priority rules that are utilized to determine priority scores for messages. For example, the priority rules module 420 may determine a priority rule by identifying a subset of rule components from among a plurality of rule components and determine corresponding weights for each of the subset of rule components. The priority rules engine 420 may determine a subset of rule components for a particular priority rule based on an analysis of message data. In some cases, the analysis may be performed with respect to messages of one or more individuals, for an organization, or both. To illustrate, by analyzing message data for one or more individuals and/or analyzing message data for an organization, the priority rules module 420 may determine that certain attributes of messages are indicators of the priority of messages in relation to other indicators. In these scenarios, the priority rules module 420 may generate a priority rule including rule components associated with the identified attributes. Additionally, the priority rules module 420 may determine, based on the analysis of message attributes, weights to assign to each rule component. In some cases, the priority rules determined by the priority rules module 420 based on analyzing message data may be designated as default rules for one or more individuals and/or an organization.

The priority rules module 420 may also determine at least a portion of a priority rule based on input received from an individual, input received from an organization, or both. For example, the priority rules module 420 may receive input indicating that certain components are to be included in a priority rule. Additionally, the priority rule module 420 may receive input indicating that a particular weight is to be assigned to a component of a priority rule.

The priority rules module 420 may also determine values for the rule components of a priority rule based on attributes of messages. For example, the priority rules module 420 may obtain message metadata that corresponds with attributes of a message and determine values for rule components based on the attributes of the message. In some cases, the values of the attributes may be determined according to a scheme, such as a scheme discussed previously with respect to Tables 1-4. In a particular example, the priority rules module 420 may perform an analysis of message metadata for a message received by an individual and determine that the message is a courtesy copy of the message. In these embodiments, the priority rules module 420 may determine a score for a rule component related to recipient status based on the message being a courtesy copy.

After determining values for the rule components of a priority rule, the priority rules module 420 may determine a priority score for each message of a plurality of messages. In a particular example, the priority score may be determined according to the following formula:

$$Priority Score = \frac{{\sum }_{i = 0}^{n} Wi \times Vi}{{\sum }_{i = 0}^{n} Wi}$$

### Where

Wi stands for different weight factors associated with the different rule components and
Vi stands for the values for the rule components.
That is, the priority rules module 420 may determine a priority score for a message based on a sum of the product of the values for each priority rule component of a priority rule and the corresponding weights of the respective priority rule component divided by the sum of the weights of the rule components of the priority rule. The priority rules module 420 may utilize the priority scores for a number of messages to determine an order for the number of messages. In some embodiments, the priority rules module 420 may arrange the messages in decreasing order with the first message having the greatest priority score and the last message having the lowest priority score.

In an illustrative example, the priority rules module 420 may determine values of components of priority rules by performing an analysis of messages associated with a plurality of message accounts of the individual 412. In particular, the priority rules module 420 may perform an analysis of at least message metadata obtained by the message metadata collection module 418 for a first message account of the individual 412 and a second message account of the individual 412. For example, the priority rules module 420 may determine a priority rule by which to analyze the messages of the individual 412. The priority rules module 420 may then perform an analysis of attributes of the messages that correspond with components of the priority rule and assign values to the components based on the analysis. The priority rules module 420 may utilize the values of the components of the priority rule and the corresponding weights of the components to determine priority scores for the messages of the first message account of the individual 412 and the second message account of the individual 412. Based at least partly on the priority scores, the priority rules module 420 may order the messages from the first message account of the individual 412 and the second message account of the individual 412.

The prioritized view module 422 may include computer-readable instructions that are executable by the processor 414 to generate information associated with a user interface that shows messages arranged according to the order determined by the priority rules module 420. The user interface including the messages arranged according to the order determined by the priority rules module 420 may be referred to herein as a prioritized view. In some cases, the user interface may include a subset of the messages ordered by the priority rules module 420. For example, a first page of the user interface may include a first group of the messages, while a second page of the user interface may include a second group of the messages ordered by the priority rules module 420. The user interface may include an identifier of each message and other information associated with each message. To illustrate, the user interface may indicate a time that a message was received, a sender of the message, one or more recipients of a message, a subject or title of a message, a message account associated with a message, attachments of a message, or combinations thereof. In particular embodiments, the prioritized view module 422 may provide information related to the user interface to a computing device such that the computing device may render the user interface.

The user action module 424 may include computer-readable instructions that are executable by the processor 414 to receive and process input related to actions that may be performed with respect to messages included in a prioritized view generated by the prioritized view module 422. For example, the user action module 424 may receive data from a computing device indicating input corresponding to an action performed by an individual. To illustrate, the user action module 424 may receive data indicating input from an individual to open the content of a message. In another illustration, the user action module 424 may receive data indicating input from an individual to reply to a message. In an additional illustration, the user action module 424 may receive data indicating input from an individual to forward a message.

The user action module 424 may communicate with the message account providers 408 regarding user actions. In some embodiments, the user action module 424 may send information to a message account provider 408 indicating that content of a message has been opened. In this way, the user action module 424 may synchronize the information of the service provider 404 regarding a message with the information of a message account provider 408 regarding the message. Thus, if a message is opened or otherwise acted upon outside of the prioritized view, any changes to the message that occurred within the prioritized view may be propagated to the underlying message account. In situations where a message is replied to or forwarded, the user action module 424 may facilitate the communication of the message to the intended recipient and report data associated with the communication of the message to the corresponding message account provider 408. Also, in situations where a message is replied to or forwarded, the user action module 424 may send an indication to the corresponding message account provider 408 that a message is to be forwarded or replied to and the corresponding message account provider 408 may facilitate the forwarding or reply to the message. In these cases, the user action module 424 may also send identifiers of the intended recipients of the message to the corresponding message account provider 408.

In addition, the user action module 424 may invoke the priority rules module 420 based on receiving information corresponding to an action with respect to a message. For example, when the user action module 424 determines that message content has been accessed, that a message has been forwarded, that a message has been replied to, that a message has been deleted, that another input related to another action has been received, or combinations thereof, the user action module 424 may provide information regarding the action to the priority rules module 420. In these situations, the priority rules module 420 may determine that a priority score for a message is to be re-calculated based on the information received from the user action module 424. In particular, the priority rules module 420 may determine that a component of a priority rule for a message may be related to a user action, such as accessing the message or replying to the message. The priority rules module 420 may re-calculate the value of the component based on the change in the data associated with the message. The priority rules module 420 may then determine a different position for the message within the ordered messages and send the new ordering of the messages to the prioritized view module 422. The prioritized view module 422 may then modify the prioritized view to reflect the new ordering of the messages.

The message content collection module 426 may include computer-readable instructions that are executable by the processor 414 to obtain message content from the message account providers 408. The message content for a message may include body of text of the message, video of a message, audio of a message, attachments of the message, links associated with a message, or combinations thereof. In some cases, the message content collection module 426 may obtain message content based on information indicating that an individual has provided input to open the message content of a message. In other cases, the message content collection module 426 may obtain message content from the message account providers 408 based on a component of a priority rule being related to the message content. For example, a component of a priority rule may be related to one or more keywords being included in the body of a message and the message content collection module 426 may obtain the message content so that the priority rules module 420 may analyze the message content to determine a value for the keyword related component of the priority rule. By refraining from collecting message content until a limited number of scenarios arise, the system 400 may minimize network and computing resources used by the system 400 to determine priority scores for messages.

The feedback module 428 may include computer-readable instructions that are executable by the processor 414 to process feedback received that relates to the ordering of messages in a prioritized view. For example, the feedback module 428 may receive information indicating input from an individual to change a position of a message within a prioritized view. In some cases, changing the position of a message within a prioritized view may include increasing the position of the message indicating an increased priority of the message. In other cases, changing the position of the message within the prioritized view may include decreasing the position of the message indicating a decreased priority of the message.

Based on determining that a position of a message within the prioritized view has changed, the feedback module 428 may perform an analysis or invoke the priority rules module 420 to perform an analysis to determine attributes of the message that correspond with the change in position of the message. In particular embodiments, the analysis may compare attributes of the message associated with the changed position and attributes of other messages. In some cases, the analysis may compare attributes of the message associated with the changed position and attributes of additional messages having a priority score within a threshold of the priority score of the message associated with the changed position. Based on the analysis, the feedback module 428 and/or the priority rules module 420 may identify one or more attributes of the message that are related to the change in position of the message. The feedback module 428 and/or the priority rules module 420 may modify a weight associated with the component of a priority rule that corresponds to the one or more attributes identified in the analysis. Additionally, the feedback module 428 may receive information corresponding to direct input from an individual indicating the attributes of a message that have greater importance than other attributes. In these scenarios, the feedback module 428 and/or the priority rules module 420 may modify components and/or weights in priority rules that correspond with the attributes indicated by the input provided by the individual.

The electronic device 410 of the system 400 may include a processor 436 and computer-readable storage media 438. The processor 436 may include a hardware-processing unit, such as a central processing unit, a graphics processing unit, or both. In an implementation, the computer-readable storage media 438 may include volatile and nonvolatile memory and/or removable and non-removable media implemented in any type of technology for storage of information, such as computer-readable instructions, data structures, program modules, or other data. Such computer-readable storage media 438 may include, but is not limited to, RAM, ROM, EEPROM, flash memory or other memory technology, CD-ROM, digital versatile disks (DVD) or other optical storage, solid state storage, magnetic disk storage, removable storage media, or any other medium that may be used to store the desired information and that can be accessed by the electronic device 410. Depending on the configuration of the electronic device 410, the computer-readable storage media 438 may be a type of tangible computer-readable storage media and may be a non-transitory storage media. The electronic device 410 may also include one or network interfaces (not shown) to communicate with other computing devices via the one or more networks 406. The electronic device 410 may also include one or more input/output devices 440. For example, the electronic device 410 may include and/or be in communication with one or more display devices, a touch screen, a keypad, a keyboard, a pointer device, one or more speakers, a microphone, one or more cameras, combinations thereof, and the like.

The computer-readable storage media 438 may store a content access application 442 that is executable by the processor 436 to obtain and display content, such as a user interface including a prioritized view provided by the service provider 404. In some cases, the content access application 442 may include a browsing application that may render a Web-based version of a user interface including a prioritized view based on information obtained from the computing device 402. In other cases, the content access application 442 may include a specialized mobile device app that may render a user interface including a prioritized view based on information obtained from the computing device 402.

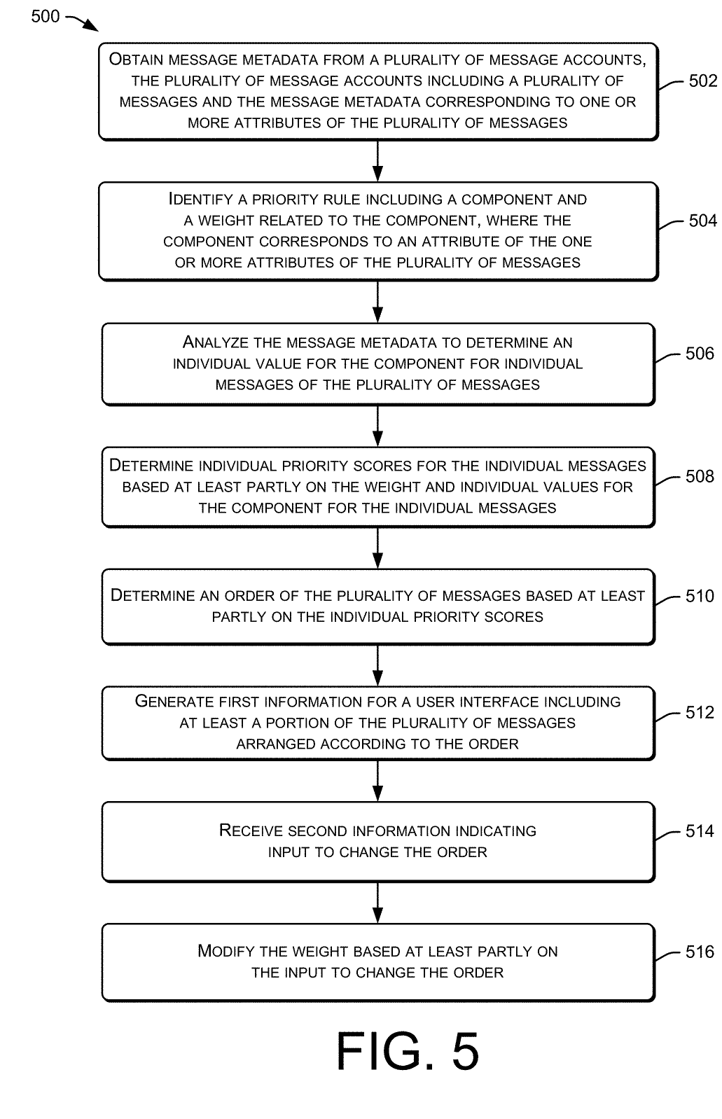

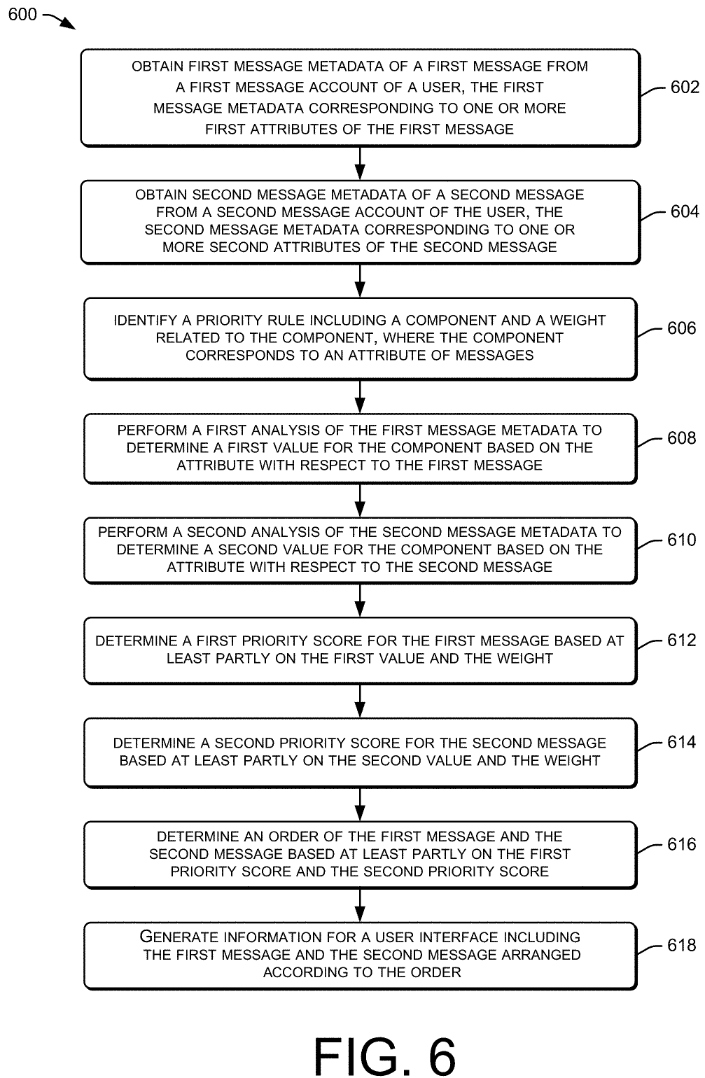

In the flow diagrams of FIGS. 5 and 6, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 500 and 600 may be described with reference to FIG. 1, 2, 3, or 4 as described above, although other models, frameworks, systems and environments may implement these processes.

FIG. 5 is a flowchart of a first example process 500 to prioritize messages according to some embodiments. At 502, the process 500 includes obtaining message metadata from a plurality of message accounts. The plurality of message accounts may be associated with the same individual. The plurality of message accounts may include a plurality of messages and the message metadata may correspond to one or more attributes of the plurality of messages. The plurality of messages may include at least one of emails, short message service (SMS) messages, multimedia messaging service (MMS) messages, instant messages, messages of a chat application, messages of an instant messaging application, messages of a microblogging application, or messages of a forum. In some cases, obtaining the message metadata from the plurality of message accounts may include obtaining a first portion of the message metadata from a message account provider according to application programming interface (API) calls associated with the message account provider. The message account provider may administer a message account of the plurality of message accounts. In various embodiments, additional information may also be obtained from the message account providers. To illustrate, a service provider may send a request to a message account provider associated with a message to obtain message content corresponding to the message (e.g., text included in a body of the message). The service provider may receive the message content from the message account provider. In certain situations, the service provider may generate information related to a user interface that includes the message content.

At 504, the process 500 includes identifying a priority rule. The priority rule may include a component and a weight related to the component. The component may correspond to an attribute of the one or more attributes of the plurality of messages. For example, the component may correspond to an importance/category flag of messages. In another example, the component may correspond to a number of attachments of messages. In an additional example, the component of the priority rule may be related to an organizational chart of an organization. The organizational chart may include a plurality of levels and individual levels of the plurality of levels may be associated with one or more positions within the organization.

At 506, the process 500 includes analyzing the message metadata to determine an individual value for the component for individual messages of the plurality of messages. In some embodiments, analyzing the message metadata to determine an individual value for the component for individual messages of the plurality of messages may include determining a value for the component for a message of the plurality of messages by comparing message metadata of the message to a scheme that specifies a plurality of values for the component based on an attribute of messages.

At 508, the process 500 includes determining individual priority scores for the individual messages based at least partly on the weight and individual values for the component for the individual messages. At 510, the process 500 includes determining an order of the plurality of messages based at least partly on the individual priority scores. In some embodiments, determining the order of the plurality of messages may include comparing the individual priority scores of the plurality of messages with respect to one another and arranging the individual priority scores in decreasing order.

At 512, the process 500 includes generating first information for a user interface including at least a portion of the plurality of messages arranged according to the order. At 514, the process 500 includes receiving second information indicating input to change the order. In some cases, the messages included in the user interface may be selectable. In these situations, the input to change the order may include selection of the message and moving the message from a first position within the user interface to a second position. At 516, the process 500 includes modifying the weight based at least partly on the input to change the order.

In particular embodiments, some actions taken by an individual may modify the priority score for a message. For example, a priority score for the message may be modified based at least partly on the input to reply to the message. Additionally, the order may be modified when the priority scores are modified. To illustrate, the order of the plurality of messages may be modified based at least partly on modifying the priority score for the message to produce a modified order of the plurality of messages. In situations where the order is modified, additional information for a modified user interface may be generated where the user interface indicates the modified order of the plurality of messages.

In some cases, a service provider performing the operations of the process 500 may perform additional operations. For example, information may be received indicating input to reply to a message of the plurality of messages. In these cases, the service provider may send additional information to a message account provider associated with the message to send a reply message in relation to the message. The additional information may include information to be utilized by the message account provider to send the reply message, such as an identifier of a recipient of the reply message (e.g., an email address or phone number) and text of the reply message. In another example, a service provider may receive input indicating a request to open a message of the plurality of messages.

Additionally, a service provider may determine that an individual has performed an action with respect to a message of the plurality of messages and identify a message account provider associated with the message. In these instances, the service provider may send information to the message account provider indicating that the individual has performed the action in order to synchronize the actions taken with respect to the prioritized view shown in the user interface with the underlying message account.

FIG. 6 is a flowchart of a second example process 600 to prioritize messages according to some embodiments. At 602, the process 600 includes obtaining first message metadata of a first message from a first message account of a user. The first message metadata may correspond to one or more first attributes of the first message. At 604, the process 600 includes obtaining second message metadata of a second message from a second message account of the user. The second message metadata may correspond to one or more second attributes of the second message. In particular embodiments, the first message may be sent at a first time and the second message may be sent at a second time, the first message account may be administered by a first message account provider, and the second message account may be administered by a second message account provider.

At 606, the process 600 includes identifying a priority rule that includes a component and a weight related to the component. The component may correspond to an attribute of messages. In some cases, the priority rule may include a subset of a plurality of components with individual components of the plurality of components corresponding to an attribute of a plurality of messages. In these instances, the process 600 may include performing an analysis of attributes of the plurality of messages to identify the subset of the plurality of components.

At 608, the process 600 includes performing a first analysis of the first message metadata to determine a first value for the component based on the attribute with respect to the first message. At 610, the process 600 includes performing a second analysis of the second message metadata to determine a second value for the component based on the attribute with respect to the second message.

At 610, the process 600 includes determining a first priority score for the first message based at least partly on the first value and the weight. At 612, the process 600 includes determining a second priority score for the second message based at least partly on the second value and the weight.

At 614, the process 600 includes determining an order of the first message and the second message based at least partly on the first priority score and the second priority score. In some embodiments, the first priority score may be greater than the second priority score and the first message may be placed in a higher position than the second message. That is, the first message may be placed closer to the top of a user interface than the second message.

At 616, the process 600 includes generating information for a user interface including the first message and the second message arranged according to the order. In some cases, the process 600 may include receiving information indicating input from an individual to change the order and modifying the weight based at least partly on the input to change the order.

Additionally, new messages may also be processed by a service provider implementing the process 600 with message metadata of a new message being obtained by the service provider. The new message may be sent at a time after the first message is sent and after the second message is sent. In these embodiments, a service provider may perform an analysis of the message metadata of the new message to determine a value for the component of the priority rule based on the attribute with respect to the new message. Also, the service provider may determine a priority score for the new message based at least partly on the value and the weight for the third message. In some cases, priority score for the new message may be greater than one of the priority score for the first message and/or the second message. In another embodiment, the priority score for the new message may be greater than the priority score for the second message and less than the priority score for the first message. Based on the priority score for the new message with respect to the first message and the second message, a service provider may determine a new order for the first message, the second message, and the new message based at least partly on the first priority score, the second priority score, and the priority score of the new message. Further, the service provider may modify a user interface to include the first message, the second message, and the new message arranged according to the new order.

In some cases, the priority scores for message may be modified. For example, a service provider may determine that an individual has performed an action with respect to the first message. In these situations, the service provider may modify a value of an additional component of the priority rule based at least partly on the action being performed with respect to the first message. The service provider may then determine an additional priority score for the first message based at least partly on the value of the additional component and a respective weight associated with the additional component. Further, the service provider may determine an additional order for the first message and the second message with the additional order being different from the initial order. The service provider may then generate additional information for an additional user interface that includes the first message and the second message arranged according to the additional order. In various embodiments, the first priority score may initially be greater than the second priority score and the action may include opening the first message. Upon performing the action of opening the first message, the service provider may determine that the new priority score for the first message is less than the initial priority score for the first message.

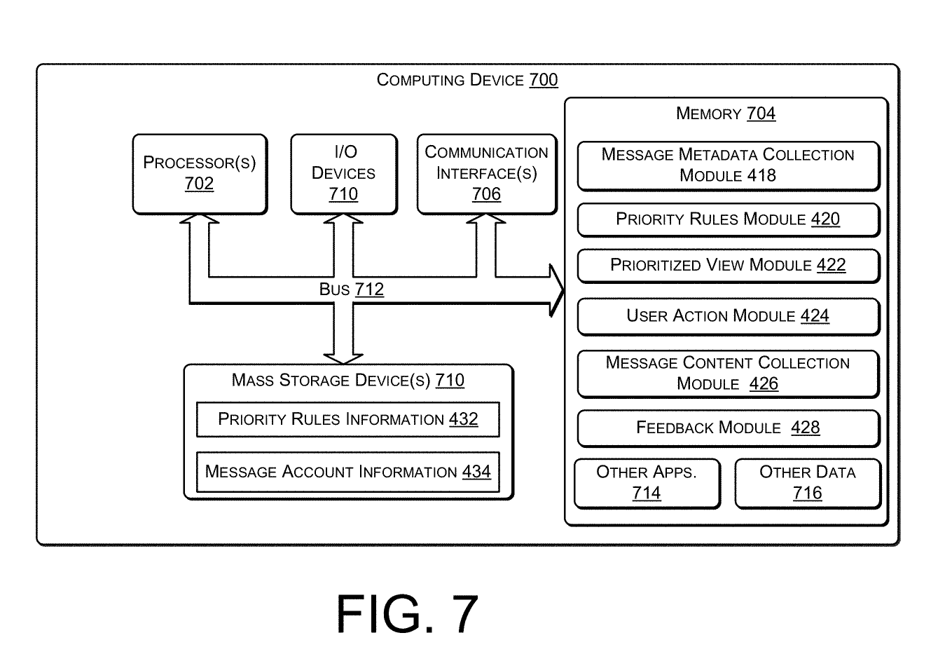

FIG. 7 illustrates an example configuration of a computing device 700 that can be used to implement the systems and techniques described herein according to some embodiments. In some cases, the computing device 700 may be a server. The computing device 700 may include one or more processors 702, a memory 704, communication interfaces 706, input/output (I/O) devices 708, and one or more mass storage devices 710, configured to communicate with each other, such as via a system bus 712 or other suitable connection.

The processors 702 may include a single processing unit or a number of processing units, all of which may include single or multiple computing units or multiple cores. The processors 702 can be implemented as one or more microprocessors, microcomputers, microcontrollers, digital signal processors, central processing units, state machines, logic circuitries, and/or any devices that manipulate signals based on operational instructions. Among other capabilities, the processors 702 can be configured to fetch and execute computer-readable instructions stored in the memory 704, mass storage devices 710, or other computer-readable media.

Memory 704 and mass storage devices 710 are examples of computer storage media for storing instructions which are executed by the processors 702 to perform the various functions described above. For example, memory 704 may generally include both volatile memory and non-volatile memory (e.g., RAM, ROM, or the like). Further, mass storage devices 710 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 704 and mass storage devices 710 may be collectively referred to as memory or computer storage media herein, and may be a non-transitory media capable of storing computer-readable, processor-executable program instructions as computer program code that can be executed by the processor 702 as a particular machine configured for carrying out the operations and functions described in the implementations herein. The memory of the computing device 700 may be used to store the priority rules information 432, the message account information 434, or both.

The computer storage media, such as memory 704 and mass storage devices 710, may be used to store software applications and data. For example, the computer storage media may include software applications, such as, for example, the message metadata collection module 418, the priority rules module 420, the prioritized view module 422, the user action module 424, the message content collection module 426, and the feedback module 428.

The computing device 700 may also include one or more communication interfaces 706 for exchanging data via a network. The communication interfaces 706 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet, and the like. Communication interfaces 706 can also provide communication with external storage (not shown), such as in a storage array, network attached storage, storage area network, or the like.

I/O devices 710 may be devices that receive various inputs from a user and provide various outputs to the user, and may include a display device, keyboard, a remote controller, a mouse, a printer, audio input/output devices, and so forth.

The example systems and computing devices described herein are merely examples suitable for some implementations and are not intended to suggest any limitation as to the scope of use or functionality of the environments, architectures and frameworks that can implement the processes, components and features described herein. Thus, embodiments herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry), or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example embodiments, as described and as illustrated in the drawings. However, this disclosure is not limited to the embodiments described and illustrated herein, but can extend to other embodiments, as would be known or as would become known to those skilled in the art. Reference in the specification to “one embodiment,” “this embodiment,” “these embodiments” or “some embodiments” means that a particular feature, structure, or characteristic described is included in at least one implementation, and the appearances of these phrases in various places in the specification are not necessarily all referring to the same embodiment.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present invention have been illustrated herein in the Drawings and described in the Detailed Description, it will be understood that the invention is not limited to the embodiments disclosed, but is capable of numerous rearrangements, modifications and substitutions without departing from the scope of the present disclosure.

What is claimed is:

1. A computer-implemented method comprising:
obtaining first message metadata of a first message from a first message account of a user, the first message metadata corresponding to one or more first attributes of the first message;
obtaining second message metadata of a second message from a second message account of the user, the second message metadata corresponding to one or more second attributes of the second message;
identifying a priority rule including a component and a weight related to the component, wherein the component corresponds to an attribute of messages;
performing a first analysis of the first message metadata to determine a first value for the component based on the attribute with respect to the first message;
performing a second analysis of the second message metadata to determine a second value for the component based on the attribute with respect to the second message;
determining a first priority score for the first message based at least partly on the first value and the weight;
determining a second priority score for the second message based at least partly on the second value and the weight;
determining an order of the first message and the second message based at least partly on the first priority score and the second priority score; and
generating information for a user interface including the first message and the second message arranged according to the order.

2. The computer-implemented method of claim 1, further comprising:
receiving information indicating input to change the order; and
modifying the weight based at least partly on the input to change the order.

3. The computer-implemented method of claim 1, further comprising:
determining that an action has performed with respect to the first message;
modifying an additional value of an additional component of the priority rule based at least partly on performing the action with respect to the first message;
determining an additional first priority score for the first message based at least partly on the additional value and an additional weight associated with the additional component;
determining an additional order for the first message and the second message, the additional order being different from the order; and
generating additional information for an additional user interface that includes the first message and the second message arranged according to the additional order.

4. The computer-implemented method of claim 3, wherein:
the first priority score is greater than the second priority score;
the action includes opening the first message; and
the additional first priority score is less than the first priority score.

5. The computer-implemented method of claim 1, wherein the priority rule includes a subset of a plurality of components, individual components of the plurality of components corresponding to an attribute of a plurality of messages; and the method further comprises:
performing an analysis of attributes of the plurality of messages to identify the subset of the plurality of components.

6. The computer-implemented method of claim 1, wherein:
the first message is sent at a first time and the second message is sent at a second time;
the first priority score is greater than the second priority score;
the first message account is administered by a first message account provider; and
the second message account is administered by a second message account provider.

7. The computer-implemented method of claim 6, further comprising:
obtaining third message metadata of a third message, wherein the third message is sent at a time after the first time and after the second time;
performing a third analysis of the third message metadata to determine a third value for the component based on the attribute with respect to the third message;
determine a third priority score for the third message based at least partly on the third value and the weight, the third priority score being greater than the second priority score and less than the first priority score;
determining an additional order for the first message, the second message, and the third message based at least partly on the first priority score, the second priority score, and the third priority score; and
modifying the user interface to include the first message, the second message, and the third message arranged according to the additional order.

8. A system, comprising:
one or more processors; and
one or more non-transitory computer-readable storage media storing instructions that are executable by the one or more processors to perform operations comprising:
obtaining message metadata from a plurality of message accounts, the plurality of message accounts including a plurality of messages and the message metadata corresponding to one or more attributes of the plurality of messages;
identifying a priority rule including a component and a weight related to the component, wherein the component corresponds to an attribute of the one or more attributes of the messages;
analyzing the message metadata to determine an individual value for the component for individual messages of the plurality of messages;
determining individual priority scores for the individual messages based at least partly on the weight and individual values for the component for the individual messages;
determining an order of the plurality of messages based at least partly on the individual priority scores; and
generating information for a user interface including at least a portion of the plurality of messages arranged according to the order.

9. The system of claim 8, wherein obtaining the message metadata from the plurality of message accounts includes obtaining a portion of the message metadata from a message account provider according to application programming interface (API) calls associated with the message account provider, the message account provider administering a message account of the plurality of message accounts.

10. The system of claim 8, wherein the operations further comprise:
determining that an action has performed with respect to a message of the plurality of messages;
identifying a message account provider associated with the message, the message account provider administering a message account of the plurality of message accounts; and
sending information to the message account provider indicating that the action has been performed.

11. The system of claim 8, wherein the operations further comprise:
receiving input indicating a request to open a message of the plurality of messages;
sending a request to a message account provider associated with the message for message content corresponding to the message;
receiving, from the message account provider, the message content; and
generating additional information for an additional user interface that includes the message content.

12. The system of claim 8, wherein the operations further comprise:
receiving information indicating input to change the order; and
modifying the weight based at least partly on the input to change the order.

13. The system of claim 8, wherein an additional component of the priority rule is related to an organizational chart of an organization, the organizational chart including a plurality of levels and individual levels of the plurality of levels being associated with one or more positions within the organization.

14. The system of claim 8, wherein analyzing the message metadata to determine an individual value for the component for individual messages of the plurality of messages includes determining a value for the component for a message of the plurality of messages by comparing message metadata of the message to a scheme that specifies a plurality of values for the component based on an attribute of messages.

15. One or more non-transitory computer-readable media, comprising instructions that are executable by one or more processors to perform operations comprising:
obtaining message metadata from a plurality of message accounts, the plurality of message accounts including a plurality of messages and the message metadata corresponding to one or more attributes of the plurality of messages;
identifying a priority rule including a component and a weight related to the component, wherein the component corresponds to an attribute of the one or more attributes of the plurality of messages;
analyzing the message metadata to determine an individual value for the component for individual messages of the plurality of messages;
determining individual priority scores for the individual messages based at least partly on the weight and individual values for the component for the individual messages;
determining an order of the plurality of messages based at least partly on the individual priority scores;
generating first information for a user interface including at least a portion of the plurality of messages arranged according to the order;
receiving second information indicating input to change the order; and
modifying the weight based at least partly on the input to change the order.

16. The one or more non-transitory computer-readable media of claim 15, wherein the operations further comprise:
receiving third information indicating input to reply to a message of the plurality of messages; and
sending fourth information to a message account provider associated with the message to send a reply message in relation to the message, the fourth information including an identifier of a recipient of the reply message and text of the reply message.

17. The one or more non-transitory computer-readable media of claim 16, wherein the operations further comprise:
modifying a priority score for the message based at least partly on the input to reply to the message;
modifying the order of the plurality of messages based at least partly on modifying the priority score for the message to produce a modified order of the plurality of messages; and
generating additional information for a modified user interface indicating the modified order of the plurality of messages.

18. The one or more non-transitory computer-readable media of claim 15, wherein:
a message of the portion of the plurality of messages included in the user interface is selectable; and
the input to change the order includes selection of the message and moving the message from a first position within the user interface to a second position.

19. The one or more non-transitory computer-readable media of claim 15, wherein the plurality of messages include at least one of emails, short message service (SMS) messages, multimedia messaging service (MMS) messages, instant messages, messages of a chat application, messages of an instant messaging application, messages of a microblogging application, or messages of a forum.

20. The one or more non-transitory computer-readable medium of claim 15, wherein determining the order of the plurality of messages includes comparing the individual priority scores of the plurality of messages and arranging the individual priority scores in decreasing order.
